(19) United States
(12) Patent Application Publication
(10) Pub. No.: US 2009/0100692 A1
(43) Pub. Date: Apr. 23, 2009

(54) LASER MARKER

(75) Inventor: Akihito TAMAMURA, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: KABUSHIKI KAISHI AUDIO-TECHNICA, Tokyo (JP)

(21) Appl. No.: 12/256,906

(22) Filed: Oct. 23, 2008

(30) Foreign Application Priority Data
Oct. 23, 2007 (JP) 2007-275697

(51) Int. Cl. G01C 15/02

(52) U.S. Cl. 33/299

(57) ABSTRACT

A light source unit holder, on which a light source unit is mounted, is rockably supported via a gimbal mechanism, and projects a brightline using a laser beam emitted from the light source unit, the gimbal mechanism includes a pair of shafts that support the rocking body rockably from both sides thereof, a spherical-body receiving hole is formed at a tip of the pair of shafts, and also in the rocking body a spherical-body receiving hole is formed in a position to which the tips of the pair of shafts face, and a spherical body is interposed between the spherical-body receiving hole of the pair of shafts and the spherical-body receiving hole of the rocking body, the latter spherical-body receiving hole facing the spherical-body receiving hole of each shaft, so that the rocking body is rockably supported, for preventing dynamic sensitivity of the gimbal mechanism from decreasing.

### BACKGROUND OF THE INVENTION

1. Field of the Invention

The present invention relates to a laser marker that projects a marking laser line light (hereinafter, referred to as a “brightline”) to a surface to be projected, such as a wall, a ceiling, or a floor, in a construction site or the like. In particular, the present invention relates to a structure of a supporting member that rockably supports a light source unit holder of the laser marker.

2. Related Background of the Invention

The laser marker converts divergent light, which is emitted from a laser light source such as a semiconductor laser, into a parallel beam by means of a collimate lens, and then transmits this beam through a cylindrical rod lens and thereby diffuses this only in one direction and projects this diffusion light to a surface to be projected, such as a wall, a ceiling, and a floor. The laser beam projected onto the surface to be projected serves as a vertical brightline or a horizontal brightline. The laser marker is suspended so that the light source unit holder may always maintain a predetermined attitude by means of a suspension mechanism. To the light source unit holder, a light source unit comprising a semiconductor laser, a collimate lens, a rod lens, and the like that are integrally held by a holder is assembled. Because the light source unit always maintains a predetermined attitude by the light source unit holder being suspended as described above, the vertical or horizontal brightline is adapted to be projected properly even if the installed attitude of the body of the laser marker is inclined. Several laser markers include a vertical pointer function that can project an optical point serving as a reference onto a ceiling surface right above an installation reference point, or a mark projection function that can project an optical point serving as a reference onto a floor surface directly under the installed laser marker.

As the suspension mechanism of the light source unit holder, a gimbal mechanism is usually used. The gimbal mechanism comprises a gimbal frame that is secured substantially integrally with the body of the laser marker, a first horizontal shaft provided in the gimbal frame, an intermediate rocking body that is rockably supported about the first horizontal shaft, and a second horizontal shaft provided in the direction perpendicular to the first horizontal shaft in the intermediate rocking body. With the second horizontal shaft, the light source unit holder is rockably suspended about the second horizontal shaft.

FIG. 5 shows an example of a laser marker known in the related art. In FIG. 5, reference numeral 50 denotes a base of the laser marker. The base 50 is incorporated in a cover of the laser marker and also has a tripod for adjusting the height positions of three points and thereby taking an approximately horizontal attitude. The above-described cover and tripod are not illustrated here. Four posts 52 are erected on the upper surface of the base 50. A gimbal frame 55 is supported by the top ends of four posts 52. The gimbal frame 55 integrally includes a rectangular window frame-shaped body part, and four legs 56 extending outward from four corners of this body part, wherein each of the four legs 56 is connected to the top end of the post 52 via an insulator 54, respectively.

The light source unit holder 80 is rockably suspended by the gimbal frame 55. This suspension structure is as follows. An intermediate rocking body 60 is interposed between the gimbal frame 55 and the light source unit holder 80. With the interposition of the intermediate rocking body 60, the light source unit holder 80 is suspended. The intermediate rocking body 60 forms a rectangular parallelepiped, and in a pair of mutually parallel side surfaces a first shaft 62 (only one shaft is shown in FIG. 5) in the horizontal direction is supported rotatably about the center axis with the interposition of a bearing. In other pair of mutually parallel side surfaces of the intermediate rocking body 60, a second shaft (not shown) in the horizontal direction perpendicular to the direction of the first shaft 62 is supported rotatably about the center axis with the interposition of a bearing. The intermediate rocking body 60 is inserted into a window hole of the gimbal frame 55 with a space, and the paired first shaft 62 is inserted into a bearing hole of the gimbal frame 55, and thereby the intermediate rocking body 60 is supported rotatably about the first shaft 62.

The light source unit holder 80 is rockably supported by the second shaft. In the upper end of the light source unit holder 80, there is a coupling part 82 projecting to both sides, and a pair of coupling parts 76 of a gimbal 70 are overlapped onto the coupling part 82 and these coupling parts are fastened with a screw, and thereby the light source unit holder 80 and the gimbal holder 70 are integrally connected to each other. Approximately a half of the lower side of the gimbal holder 70 is formed in a portal shape, and a pair of bearings extend upwardly from both sides of this portal-shaped upper end surface, and the second shaft is inserted into this bearing, whereby with respect to the intermediate rocking body 60 the light source unit holder 80 is supported rockably about the second shaft.

As described above, the light source unit holder 80 is suspended rockably in all the directions by means of the first shaft 62 and the second shaft with the interposition of the intermediate rocking body 60. For this reason, even if the laser marker is inclined when the laser marker is installed, the light source unit holder 80 can always take a predetermined vertical attitude. On the side of the light source unit holder 80, a light source unit 84 for emitting a horizontal brightline is assembled in an intermediate portion in the length direction (vertical direction), while on the side near the upper end of the light source unit holder 80, a light source unit 86 for emitting a vertical brightline is assembled. Either of these light source units comprises a semiconductor laser source for emitting a laser beam, a collimate lens that converts the divergent light from the semiconductor laser source into a parallel beam, and a cylindrical lens for diffusing this parallel beam only in one direction. One light source unit 84 described above is for emitting the horizontal brightline onto a wall or the like of a building, and is mounted, with the cylindrical lens facing the vertical direction. Other light source unit 86 described above is for emitting the vertical brightline onto a wall, a ceiling, a floor, or the like of a building, and is mounted, with the cylindrical lens facing the horizontal direction. Moreover, the light source unit 86 is mounted with the optical axis facing diagonally upward so that the vertical brightline can be emitted from a floor to a wall over to a ceiling of a building.

In this way, the gimbal mechanism comprises the gimbal frame 55, the first horizontal axis 62, the intermediate rocking body 60, and the second horizontal axis. With this gimbal mechanism, the light source unit holder 80 is suspended freely rockably. The mechanical resistance of the gimbal mechanism is preferably all but close to zero. This is because if the gimbal mechanism has a mechanical resistance, the light source unit holder 80 cannot take a predetermined ideal rest position and the rest position will vary, and as a result, the positional accuracy of the brightline projected to a surface to be projected will deteriorate. For this reason, the mechanical resistance of the gimbal mechanism is reduced by interposing a ball bearing between the first and second horizontal shafts constituting the gimbal mechanism, and the intermediate rocking body or the light source unit holder 80 that is rockably supported by these horizontal shafts. For example, the markers described in Patent Document 1 and Patent Document 2 are the examples therefor. Examples of the laser marker, in which a shaft is supported by interposing a ball bearing, are described also in many patent documents other than the Patent Document 1 and Patent Document 2.

[Patent Document 1] Japanese Unexamined Patent Application Publication No. 2004-125630

[Patent Document 2] Japanese Unexamined Patent Application Publication No. 2006-250570

FIG. 3 shows a part of the gimbal mechanism interposing a ball bearing as described above. In FIG. 3, in mutually opposing walls 555 of the gimbal frame 55, there are formed female screws that horizontally pass through these walls, and a thread part 621 of the shaft 62 is screwed into the female screw. A tip part 622 of each shaft 62 penetrates inwardly of the gimbal frame 55, and the intermediate rocking body 60 is supported by the tip part 622 with the interposition of a ball bearing 40. More specifically, the inner ring of the ball bearing 40 is fitted into the outer periphery of the tip part 622 of the shaft 62, and the outer ring of the ball bearing 40 is fitted into the inner periphery of a shaft hole 601 of the intermediate rocking body 60. The center axis of each shaft 62 is adjusted so as to be aligned on a straight line. In this manner, via the ball bearing 40 having a small frictional resistance, and also with the center axis of the shaft 62 as the rocking center, the intermediate rocking body 60 will be supported by the gimbal frame 55.

Although not shown in FIG. 3, the intermediate rocking body 60 rockably supports the light source unit holder via the second horizontal shaft, as described above. Although the second horizontal shaft usually consists of one continuous shaft, a ball bearing is interposed also between the second shaft and the light source unit holder. The coupling structure between the intermediate rocking body 60 and the light source unit holder is also the same as the coupling structure using the horizontal shaft and the ball bearing, and such structure is also the same as the coupling structure between the gimbal frame 55 and the intermediate rocking body 60 shown in FIG. 3. Accordingly, the illustration thereof is omitted.

According to the gimbal mechanism shown in FIG. 3, since the intermediate rocking body 60 is rockably supported to the gimbal frame 55 via the shaft 62 and the ball bearing 40, the intermediate rocking body 60 will rock smoothly with a small mechanical resistance. Moreover, since the intermediate rocking body 60 and the light source unit holder are also rockably supported via the shaft and the ball bearing, the light source unit holder will smoothly rock with a small mechanical resistance. Consequently, the smaller the mechanical frictional resistance of each ball bearing, the smaller the variation of the rest position of the light source unit holder becomes, and thus a brightline having a high positional accuracy can be projected. A state where the mechanical frictional resistance of the ball bearing is small and the variation of the rest position of the light source unit holder is small is described as “the dynamic sensitivity of a gimbal mechanism is high.”

### SUMMARY OF THE INVENTION

### [Problems to be Solved by the Invention]

However, as in the gimbal mechanism of the related art laser marker, according to a mechanism interposing a ball bearing in a journalportion, the cost of the ball bearing is high, which increases the cost of the laser marker. In particular, in order to improve the accuracy of the laser marker, a highly-accurate and expensive ball bearing having a small frictional resistance is required, and in addition, a plurality of ball bearings are required. Accordingly, these bearings account for most of the high cost factors.

Moreover, in the gimbal mechanism of the laser marker, the horizontal shaft that rockably supports the intermediate rocking body by means of the gimbal frame mostly consists of two shafts having a common center axis, like the example shown in FIG. 3. In the case of such journaling structure, if the center axes of the two shafts exist on a common line accurately, a brightline having a high positional accuracy can be projected as described above. However, it is not easy to adjust so that the center axes of the two shafts may be positioned on a common line accurately, and thus the center axes of the two shafts may deviate from each other as shown in FIG. 4. FIG. 4 shows an extremely deviated state in order to plainly describe the deviation in the center axes. As the factors causing the center axes of the two shafts to deviate from each other this way, there are various factors, such as the mount position accuracy and mount attitude accuracy of each shaft 62, and the machining accuracy of the shaft hole 601 of the intermediate rocking body 60, which make it difficult to adjust so that the center axes of the two shafts may be positioned on a common line accurately. If the center axes of the two shafts deviate from each other even slightly, the frictional resistance of the ball bearing will increase and the dynamic sensitivity of the gimbal mechanism will decrease, and the positional accuracy of the brightline projected onto a surface to be projected will deteriorate.

In view of the problems of the above-described related art laser marker, it is an object of the present invention to provide a laser marker, which can reduce the component cost by designing the configuration of the gimbal mechanism, and additionally which can prevent the dynamic sensitivity of the gimbal mechanism from decreasing even if the center axes of a pair of shafts deviate from each other.

### [Means for Solving the Problems]

According to a main feature of the present invention, a laser marker, wherein a light source unit holder to which a light source unit is mounted is rockably supported via a gimbal mechanism, projects a brightline using a laser beam, the laser beam emitted from the light source unit, wherein the gimbal mechanism includes a pair of shafts that support a rocking body rockably from both sides thereof, a spherical-body receiving hole is formed at a tip of the pair of shafts, and also in the rocking body a spherical-body receiving hole is formed in a position to which tips of the pair of shafts face, and a spherical body is interposed between the spherical-body receiving hole of the pair of shafts and the spherical-body receiving hole of the rocking body, the latter spherical-body receiving hole facing the spherical-body receiving hole of each shaft.

### [Advantages of the Invention]

The rocking body rocks by relative rotation between the spherical body and a pair of shafts or by relative rotation between the spherical body and the rocking body. Even if the mutual center axes of a pair of shafts deviate from each other, there will be no variation in the contacting form or the contacting conditions between the spherical body and the spherical-body receiving hole of each shaft as well as the rocking-body receiving hole, and therefore the dynamic sensitivity of the gimbal mechanism will not decrease. Since a ball bearing does not need to be used unlike in the related art gimbal mechanism, the cost of the laser marker can be reduced.

### BRIEF DESCRIPTION OF THE DRAWINGS

FIG. 1 is a partial front cross-sectional view showing a part of a gimbal mechanism applied to a laser marker according to the present invention.

FIG. 2 is a partial front cross-sectional view showing a different embodiment of the part of the gimbal mechanism.

FIG. 3 is a partial front cross-sectional view showing a part of a gimbal mechanism applied to a related art laser marker.

FIG. 4 is a partial front cross-sectional view showing a different embodiment of the part of the related art gimbal mechanism.

FIG. 5 is a perspective view showing an example of a typical laser marker.

### DESCRIPTION OF THE PREFERRED EMBODIMENTS

Hereinafter, an embodiment of a laser marker according to the present invention will be described using accompanying drawings.

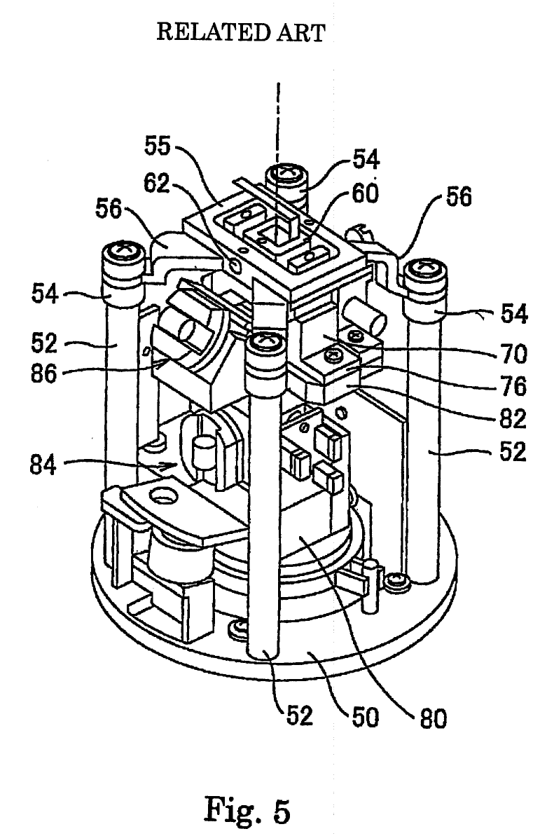

The laser marker according to the present invention is characterized in a gimbal mechanism that rockably supports a light source unit holder. The structure of the laser marker to which this gimbal mechanism is applied is not limited to the specific one, and can be applied also to a laser marker as shown in FIG. 5. Accordingly, the portion of the gimbal mechanism is described intensively, and the description of the generic configuration as the laser marker is omitted or simplified.

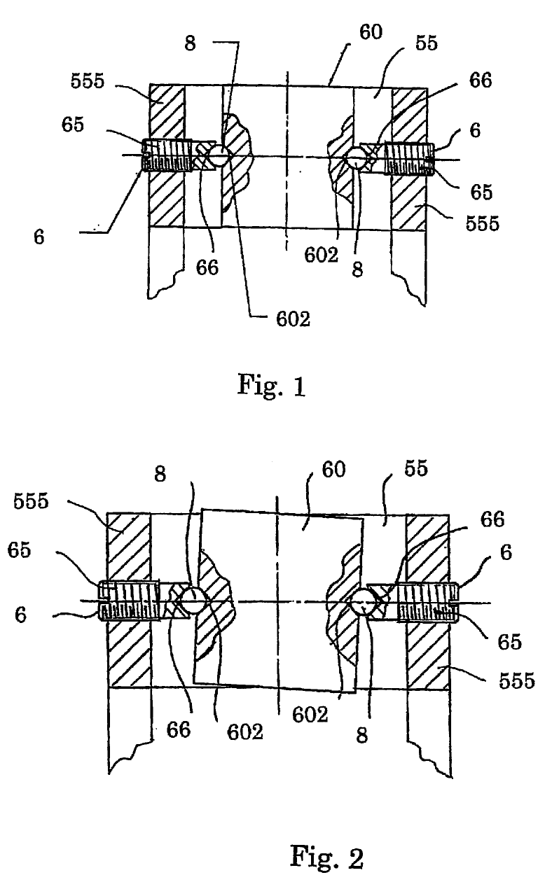

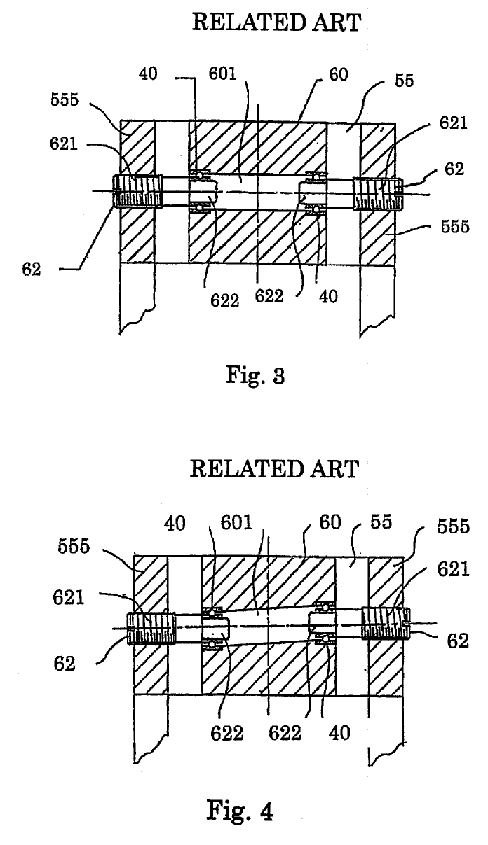

In FIG. 1, in the mutually opposing walls 555 of the gimbal frame 55, there is formed a female screw that horizontally passes through each of the walls, and a thread part 65 of the shaft 6 is screwed into the female screw. A conical shaped depression is formed at a tip of each shaft 6. This depression serves as a spherical-body receiving hole 66 that receives a part of a later-described spherical body 8. A tip part of each shaft 6 in which the spherical-body receiving hole 66 is formed penetrates inwardly of the gimbal frame 55.

In the inward of the gimbal frame 55, the intermediate rocking body 60 is disposed with a suitable space apart from the inner peripheral face of the gimbal frame 55. The intermediate rocking body 60 is formed in a cylindrical shape in which a hole vertically passes therethrough, and in a lateral surface of the mutually opposing walls, a spherical-body receiving hole 602 is formed in a position to which the tip of each shaft 6 faces. Each spherical-body receiving hole 602 of the intermediate rocking body 60 comprises a conical shaped depression, as the spherical-body receiving hole 66 of each shaft 6 does.

The spherical body 8 is interposed between the spherical-body receiving hole 66 of the pair of shafts 6 and each spherical-body receiving hole 602 of the intermediate rocking body 60, the spherical-body receiving hole 602 facing the spherical-body receiving hole 66 of each shaft 6, and a part of the outer peripheral surface of each spherical body 8 sinks into both of the spherical-body receiving hole 66 and the spherical-body receiving hole 602, and thereby the intermediate rocking body 60 is supported. Moreover, the conical-shaped peripheral wall of each of the spherical-body receiving holes 66, 602 slidingly contacts the outer periphery of the spherical body 8, so that the intermediate rocking body 60 is rockably supported. Since the conical-shaped peripheral walls of the spherical-body receiving holes 66, 602 are in line-contact with or in point-contact with the peripheral face of the spherical body 8, the frictional resistance between each shaft 6 and the intermediate rocking body 60 is small and the deterioration in the dynamic sensitivity of the gimbal mechanism can be prevented. Each spherical body 8 preferably comprises a steel ball. It is preferable to machine and select the quality of the material so that the surface roughness of the conical-shaped wall surface forming each of the spherical-body receiving holes 66, 602 and also the surface roughness of the spherical body 8 may be as high as possible, and so that the hardness thereof may be as high as possible. For the shaft 6, the body part and the tip part in which the spherical-body receiving hole 66 is formed may be separate members, and the tip part may be formed of a material having a high surface roughness and a high hardness, and the both may be integrally connected to each other.

According to the embodiment shown in FIG. 1, a spherical body, such as a steel ball, may be used without using an expensive ball bearing conventionally used, and therefore, a lower cost of the laser marker can be achieved. Moreover, since the frictional resistance between each shaft 6 and the intermediate rocking body 60 will not increase even if the mutual center axes of a pair of shafts 6 deviate from each other, the positional accuracy of the brightline projected onto a surface to be projected can be improved. FIG. 2 shows a situation where the mutual center axes of a pair of shafts 6 deviate from each other and the intermediate rocking body 60 is inclined. Even if the intermediate rocking body 60 is inclined, the contacting form or the contacting conditions between the spherical body 8 and the spherical-body receiving hole 66 of each shaft 6 as well as the spherical-body receiving hole 602 of the rocking body 60 will not vary, and therefore the sensibility of the gimbal mechanism will not deteriorate.

The paired shaft 6 adjusts the screwing amount with respect to the gimbal frame 55 so that a pressure against the spherical body 8 may not be too strong and that looseness may not occur between the spherical body 8 and the shaft 6. After finishing this adjustment., an adhesive or a lock material is applied to the thread part for fixing. Alternatively, a set screw may be screwed into the gimbal frame 55 from the direction perpendicular to the direction of the shaft 6, or a lock nut may be screwed into a thread part 65 of the shaft 6, for fixing.

FIG. 1 and FIG. 2 show an example using the spherical body 8 as the support mechanism of the intermediate rocking body 60 with respect to the gimbal frame 55. However, if a pair of shafts are used to rockably support the light source unit holder with respect to the intermediate rocking body 60, then as this support mechanism, the same mechanism as the support mechanism shown in FIG. 1 and FIG. 2 may be used. Accordingly, the same effects as the above-described effects can be obtained.

What is claimed is:

1. A laser marker, wherein a light source unit holder to which a light source unit is mounted is rockably supported via a gimbal mechanism, the laser marker projecting a brightline using a laser beam emitted from the light source unit, wherein
the gimbal mechanism includes a pair of shafts that support a rocking body rockably from both sides thereof,
a spherical-body receiving hole is formed at a tip of the pair of shafts, and also in the rocking body a spherical-body receiving hole is formed in a position to which tips of the pair of shafts face, and
a spherical body is interposed between the spherical-body receiving hole of the pair of shafts and the spherical-body receiving hole of the rocking body, the latter spherical-body receiving hole facing the spherical-body receiving hole of each shaft, so that the rocking body is rockably supported.

2. The laser marker according to claim 1, wherein the spherical-body receiving holes of the pair of shafts and the spherical-body receiving holes of the rocking body comprise a conical-shaped depression.

3. The laser marker according to claim 1, wherein the pair of shafts are mounted on a gimbal frame that is integral with a base of the laser marker, and the rocking body is an intermediate rocking body that rockably supports the light source unit holder.

4. The laser marker according to claim 3, wherein each of the pair of shafts is screwed into a screw hole formed in the gimbal frame.

5. The laser marker according to claim 1, wherein the spherical body comprises a steel ball.
